(19) United States
(12) Patent Application Publication
(10) Pub. No.: US 2006/0028059 A1
(43) Pub. Date: Feb. 9, 2006

(54) Vehicle wheel center cap with non - rotating logo at high speed rotation of the wheel

(76) Inventor: David Chun Choe, Los angeles, CA (US)

Correspondence Address: Eugene Oak, Ph., D., J.D.;Patent Attorney, 610 S. van Ness Ave., Los angeles, CA, 90005, US

(21) Appl. No.: 10/912,692

(22) Filed: Aug. 6, 2004

(51) Int. Cl. B60B 27/00

(52) U.S. Cl. 301/108.1

(57) ABSTRACT

A decorative vehicle wheel center cap bearing the vehicle manufacturer's logo in the center thereof and maintains the logo in the upright position even at high-speed rotations of the wheel. The center cap is comprised of; 1) a circular film made of 0.3 mm thickness PET (Poly Ethylene There-phthalate), which wears a logo on the front face and has a hole for a shaft at the center, 2) two plastic plates, one of which is made of transparent material such as PC (Poly Carbonate) and COC (Cyclic Olefin Copolymer), 3) a spacer surrounding the circular film with 2 mm gap and connects the two plastic plates, 4) a metal shaft penetrates the center of the circular film and connects the two plastic plates, 5) two plastic stoppers developed on the shaft placed at the front and rear of the circular film and 6) a weight attached to the rear face bottom edge of the circular film. The assembled herb center cap is evacuated to 10 torr to reduce the friction due to the air captured in the center cap.

### FIELD OF THE INVENTION

Present application refers to a vehicle wheel center cap, which maintains a vertical position of logo in the cap even at the high-speed rotation of the wheel.

### BACKGROUND OF THE INVENTION

Most vehicles carry the manufacture's emblem or logo on the front face of the car's hood, trunk's cover, and center cap of the wheels. The emblems on the front and rear of a vehicle are fixed to the non-moving part of the car to broadcast the manufacturer. For pedestrians on the street, it is easier to identify a moving vehicle's manufacture logo from the side of the vehicle. However, at least four emblems, attached on the center cap, rotate as the vehicle moves and cannot be identified by many pedestrians on the street. Therefore, these emblems on the center caps lose their function when the vehicle is moving. It is the purpose of the current application to provide a center cap, which holds the emblem in an upright position even when the vehicle's wheels rotate at high speed.

### DESCRIPTION OF THE PRIOR ART

U.S. Pat. No. 6,536,848 to Goodman, U.S. Pat. No. 6,120,104 to Okamoto, et al., U.S. Pat. No. 5,957,542 to Boothe, et al., U.S. Pat. No. 5,659,989 to Hsiao, et al., U.S. Pat. No. 5,588,715 to Harlen, U.S. Pat. No. 5,490,342 to Rutterman, et al., U.S. Pat. No. 5,190,354 to Levy, et al., U.S. Pat. No. 4,678,239 to Matsushita, U.S. Pat. No. 4,346,940 to Tatar, U.S. Pat. No. 4,280,293 to Kovalenko, and U.S. Pat. No. 2,869,262 to Lucas illustrate non-rotating wheel covers for displaying logos and signs. Their wheel cover is connected to the non-rotating part of the wheel shaft. So the sign and graphics on the wheel cover stays in an up-right position though the wheel of the vehicle rotates. However, their system is too sophisticated to realize and the mechanism may burden the existing wheel system of the vehicle. U.S. Pat. No. 4,388,771 to Lalonde, U.S. Pat. No. 3,769,729 to Engler, U.S. Pat. No. 2,869,262 to Lucas, and U.S. Pat. No. 1,832,605 to Zallio, U.S. Pat. No. 1,756,021 to Escasena, and U.S. Pat. No. 710,195 to Jones illustrate a decorative display device for a center cap of a vehicle wheel. Those devices have a disc being weighted on one side such that the disc rotates at least when the center cap is stationary, so that the design or the like is in a constant attitude.

None of the prior arts illustrates a center cap that displays an emblem or logo, which does not rotate to maintain the design in a constant up-right position, when the wheel is rotating as high speeds, as shown in the current application.

### SUMMARY OF THE INVENTION

It is purpose of the current application to provide a decorative vehicle wheel center cap that h as an inner member that rotates freely, independent of the rotation of the wheel. The inner member bears the vehicle manufacturer's logo on the front surface thereof and maintains the logo in an upright position even with the wheel moving at high-speed rotations. The center cap is comprised of 1) a circular film made of PET (Poly Ethylene There-phthalate) with 0.3 mm thickness, which bears a logo on the front face thereof and has a hole for a shaft at the center, 2) two plastic plates, at least one of which is made of transparent material such as PC (Poly Carbonate) and COC (Cyclic Olefin Copolymer), 3) a spacer surrounding the circular film with a 2 mm gap and connects the two plastic plates with 5 mm space, 4) a metal shaft penetrating the center of the circular film and connected to the two plastic plates, 5) two plastic stoppers developed on the shaft placed at the front and rear of the circular film, and 6) a weight attached to the rear face bottom edge of the circular film. The weight attached to the circular film is over 100 times the weight of the film plus the weight of the logo. The diameter of the hole at the center of the circular film is slightly larger than the diameter of the metal shaft that penetrates the circular film. The hole at the center of the circular film is treated with Teflon®. Two plastic stoppers are developed on the shaft at the front and rear of the circular film. These stoppers prevent the circular film from moving frontward and backward. All of the prior arts intended to develop a center cap mounted advertising display unit that places the advertising logo or drawings at an upright position when the wheel of the vehicle stops. Such limited function is due to the friction between the displaying member in the center cap and the shaft. The other source of the friction is between the logo displaying member and the medium captured in the center cap, such as air and liquid. Centrifugal force developed by the rotation of the wheel increases the friction between the logo displaying member and the shaft and the mounting of the shaft.

### BRIEF DESCRIPTION OF FIGURES

FIG. 1 is a front view of a center cap bearing a displaying member inside thereof according to the current application.

FIG. 2 is a cross-sectional view of the center cap and displaying member inside thereof shown along the line “A-A′” in FIG. 1.

FIG. 3 is an enlarged drawing of the section ‘B’ in FIG. 2 showing the contact point of the displaying member according to the current application.

FIG. 4 is a cross-sectional view of the center cap attached displaying member of the prior art showing the contact points and sources of frictions.

### DETAILED DESCRIPTION OF THE PREFERRED EMBODIMENTS

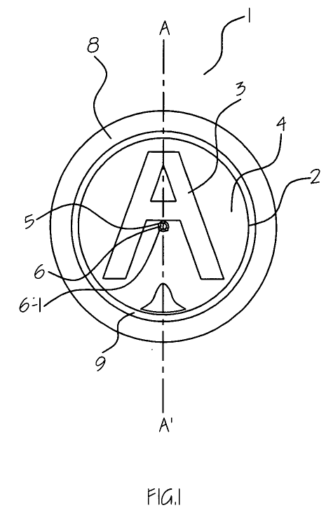

FIG. 1 is a front view of a center cap (1) bearing a displaying member (2), which is made of thin PET film, inside thereof according to the current application. Emblem (3) of the vehicle's manufacturer or other logo is placed on the front surface (4) of the displaying member.

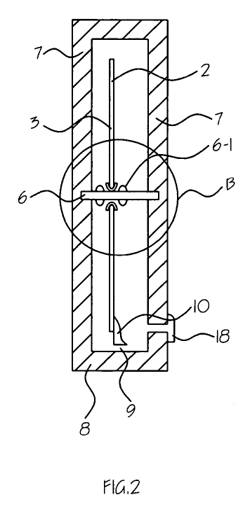

FIG. 2 is a cross sectional view of the center cap (1) and displaying member (2) shown along the line “A-A′” in FIG. 1. The center cap (1) of the current application is comprised of; 1) a displaying member (2) made of circular film of 0.5 mm thickness PET (Poly Ethylene There-phthalate), which wears a logo (3) on the front face (4) and has a hole (5) for a shaft (6) at the center, 2) two plastic plates (7), one of which is made of transparent material such as PC (Poly Carbonate) and COC (Cyclic Olefin Copolymer), 3) a spacer (8) surrounding the displaying member (2) with 2 mm gap (9) and connects the two plastic plates, 4) a metal shaft (6) that penetrates the center of the displaying member (2) and connects the two plastic plates (7), 5) two plastic stoppers (6-1) developed on the shaft and placed at the front and rear of the circular film (2), and 6) a weight (10) attached to the bottom edge of the rear face of the displaying member (2).

The mass of the weight (10) attached on the displaying member (2) is over hundred times of that of the displaying member (2) plus the logo (3).

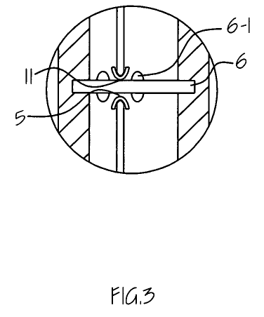

FIG. 3 is an enlarged drawing of the section ‘B’ in FIG. 2 showing the contact point of the displaying member (2) with the metal shaft (6) according to the current application. The center hole (5) of the displaying member, 0.5 mm PET film, is tapered inside and surrounded with Teflon® tape to minimize the friction between the metal shaft (6) and the displaying member (2). The diameter of the center hole (5) is slightly larger than that of the metal shaft (6). Therefore, the displaying member (2) is contacted with the rotating center cap (1). The two plastic stoppers (6-1) prevent the displaying member (2) from moving forward and backward on the shaft (6).

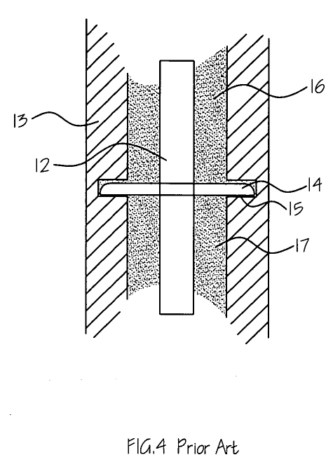

FIG. 4 is a cross sectional view of the center cap attached displaying member of the prior art, U.S. Pat. No. 4,388,771, showing the contact points and sources of frictions. In the prior art, the displaying member (12) is connected to the center cap (13) via a metal shaft (14) with two areas (15). It is clear that the larger the contacting area, the larger is the friction. Therefore, current application reduces the friction force between the rotating center cap (1) and the displaying member (2).

The other source of friction force is between the displaying member (2) and the medium filling the inner space (16) of the center cap (1). If the inner space is filled with liquid, water for example, anything in the liquid rotates with the rotation of the wheel or center cap (1). The inventor's experiment shows that at slow rotation of the center cap (1), the displaying member (2) maintains at up right position. However, if the center cap (1) rotates faster than 1,000 r.p.m. (Revolution per minute, equivalent to linear speed of 40 miles/hour of a passenger's vehicle), the displaying member (2) turns along with the center cap (1). That is due to the drag force of the liquid medium, water, i.e., another friction force. Likewise, the air (17) fills the space (16) occurs a drag force and turns the displaying member (2) at high speed of turning.

To reduce the friction force due to the air (17) in the space (16), the air (17) is evacuated to 10 torr, which is easily realized with conventional mechanical vacuum pumps, through the evacuating hole (18). For this, the spacer (8) is adhered to the two plastic plates (7) air-tightly to apply vacuum. Conventional technique of applying a strong solvent between the spacer (8) and the plastic plates (7) easily accomplishes the airtight seal. The hole (18) is blocked after evacuation.

What is claimed is:

1. A center cap for a vehicle wheel, which is comprised of;
1) A circular film made of 0.3 mm thickness PET (Poly Ethylene Therephthalate), which wears a logo on the front face and has a hole for a shaft at the center;
2) Two plastic plates, one of which is made of transparent material such as PC (Poly Carbonate) and COC (Cyclic Olefin Copolymer);
3) A spacer surrounding the circular film with 2 mm gap and connects the two plastic plates air-tightly to apply vacuum of 10 torr;
4) A metal shaft penetrate the hole, which has diameter larger than the diameter of the metal shaft, developed at center of the circular film and connects the two plastic plates;
5) Two plastic stoppers developed on the shaft placed at the front and rear of the circular film and;
6) A weight, having a mass of hundred times of the mass of the circular film plus the mass of the logo, attached to the rear face bottom edge of the circular film.
